(19) United States
(12) Patent Application Publication
(10) Pub. No.: US 2006/0189386 A1
(43) Pub. Date: Aug. 24, 2006

(54) Device, system and method for outdoor computer gaming

(75) Inventor: Louis B. Rosenberg, Arroyo Grande, CA (US)

Correspondence Address: LAW OFFICE OF PHILIP A STEINER, 4251 SOUTH HIGUERA STREET, SUITE 800-Z, SAN LUIS OBISPO, CA, 93401, US

(73) Assignee: Outland Research, L.L.C., Pismo Beach, CA (US)

(21) Appl. No.: 11/298,434

(22) Filed: Dec. 9, 2005

Related U.S. Application Data
(60) Provisional application No. 60/648,157, filed on Jan. 28, 2005.

(51) Int. Cl. A63F 13/00

(52) U.S. Cl. 463/37

(57) ABSTRACT

A system, method and device for computer gaming which utilizes actual tossable physical objects rather than virtual computer generated tossable objects as the instrument of game play. Various embodiments of the invention allow one or more players to throw and catch a physical object(s) as part of a computer moderated gaming experience. The various embodiments of the invention include a portable gaming computer in communication with a tossable gaming peripheral device, for example a ball. The portable gaming computer is programmed to wirelessly orchestrate game play and keep score. The gaming experience may be provided in a single or multi-player mode, including the use of single or multiple tossable gaming peripheral devices; maintain individual or team scores depending upon the gaming program selected or encoded into the portable gaming computer and/or tossable gaming peripheral device.

### CROSS-REFERENCE TO RELATED APPLICATIONS

This patent application is a non-provisional patent application claiming benefit and priority under 35 U.S.C. § 119(e) from applicant's co-pending U.S. provisional patent application Ser. No. 60/648,157; filed on Jan. 28, 2005. The aforementioned provisional patent application to the instant inventor of record is hereby incorporated by reference in its entirety as if fully set forth herein.

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates generally to a gaming device, system and method of use and more specifically to computerized outdoor gaming devices and methods for providing the gaming devices.

### BACKGROUND

Interactive computer entertainment is currently dominated by an indoor paradigm in which one or more players sit passively in front of a display screen and manually manipulate controller to interact with the displayed gaming action. This paradigm holds true for games on personal computers, gaming consoles, and handheld computer games. Over recent years, the realism of gaming action has improved with significantly better graphics, improved feedback, but the actual game play has changed little. It is still dominated by kids and adults sitting before a flashing screen, socially isolated, immobile and transfixed, with glassy eyes and flailing fingers. This “virtual exercise” does little for maintaining physical fitness, development of teamwork and other social skills. In particular, kids and adolescence are becoming increasingly overweight due to poor diets and lack of exercise, some of which is attributed to the sedentary nature of current computer gaming. In addition, excessive violence in video games is an unfortunate trend, exacerbated by the steadily increasing levels of visual realism.

In relation to computer games which involve some sort of projectile, for example, sports oriented games such as football or basketball games, the projectiles are simulated on a display screen and manipulated by handheld controllers.

Likewise, in action games, the projectile may be a discharge from a weapon, such as a bullet or missile or the players' character itself, hurdling across the screen. Regardless, many computer games base their play upon the motion, aim and trajectory of a controlled projectile across a graphical screen; the greater skill and precision of the player, the higher the score. While individually entertaining, the lack of actual physical exercise and real-world social interactions is still lacking.

Therefore, a fundamentally new paradigm for interactive computer entertainment is desired where play is taken off the screen, and the passive player becoming a physically active and mobile participant. The motivation for such, in this new gaming paradigm is to allow kids and adults the benefit of computer orchestrated games, but not relegate such gaming to generally stationary experiences to the indoors.

### SUMMARY

The invention as described herein addresses the desirable aspects lacking in the relevant art. The invention provides an outdoor computer gaming experience in which a portable gaming computer is programmed to orchestrate game play, including gaming rules, and scorekeeping for one or more players. The portable gaming computer is wirelessly coupled to an intelligent gaming peripheral device encompassed inside a tossable gaming object, for example a ball or flying disc.

In an device embodiment of the invention, a gaming peripheral device is generally encompassed in a tossable gaming object is provided comprising; a sensor operatively coupled to a microprocessor for communicating signals indicative of a dynamic event involving the tossable gaming object; the microprocessor being programmed to process the signals communicated by the sensor; and a wireless transceiver operatively coupled to the microprocessor for transmitting the processed sensor signals to a portable gaming computer.

In a related embodiment of the invention, the dynamic event is dependent on movement of the gaming peripheral device sufficient to actuate the sensor.

In various embodiments of the invention the dynamic event is further dependent on time, time and geospatial displacement, a numeric count and/or proximity to the portable gaming computer. In another embodiment of the invention, the gaming peripheral device is an RFID chip encompassed in the tossable gaming object.

In another related embodiment of the invention, the sensor may be one or more of an accelerometer, a GPS receiver, a proximity antenna, an inclinometer, a momentary switch, an altimeter and a timer.

In a systematic embodiment of the invention, a tossable gaming system is provided which comprises; a gaming peripheral device encompassed in a tossable gaming object including a sensor operatively coupled to a first microprocessor for communicating signals indicative of a dynamic event involving the tossable gaming object; where the first microprocessor is programmed to process the signals communicated by the sensor; a portable gaming computer in wireless communications with the gaming peripheral device including; a second microprocessor programmed to interactively orchestrate a game in dependence on the processed sensor signals and player interaction signals; and, a player interface operatively coupled to the second microprocessor for communicating the player interaction signals to the second microprocessor.

In related embodiments of the invention, the tossable gaming system includes an audio subsystem for communicating sounds to a player; where the sounds emitted from the audio subsystem include alert tones and/or sound effects; and a display for visually communicating at least one of a unit of measure and a message to the player. In another related embodiment of the invention, the interactive orchestration performed by the second microprocessor also includes moderating, scorekeeping and officiating over the game. In a final systematic embodiment of the invention, a memory is operatively coupled to the second microprocessor for storing results of the game.

In various embodiments of the invention, the tossable gaming object may be in the form of a projectile, a ball, or a disc. Likewise, in various embodiments of the invention the dynamic event may include throwing, catching, bouncing, cradling, spinning, striking, rolling, kicking, or batting of the tossable gaming object.

In a methodic embodiment of the invention, a method for making a tossable gaming peripheral is provided which comprises; providing a first microprocessor programmed to process signals communicated by a dynamic event sensor and transmit the processed signals to a second microprocessor; coupling the dynamic event sensor to the first microprocessor; coupling a first wireless transceiver to the first microprocessor; and encompassing at least the first microprocessor and the first wireless transceiver in a tossable gaming object.

A related methodic embodiment of the invention further comprises; coupling a second wireless transceiver to the second microprocessor for receiving the processed signals; coupling a player interface to the second microprocessor for communicating player interaction signals to the second microprocessor; and providing the second microprocessor; where the second microprocessor is programmed to interactively orchestrate a game in dependence on the processed sensor signals and player interaction signals; and encompassing the second microprocessor, the second wireless transceiver and the player interface in a portable case. In another related methodic embodiment of the invention the portable case is dimensioned to be of a size easily worn or hand carried by a player.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional components or feature are generally shown in dashed or dotted lines. It is intended that changes and modifications can be made to the described embodiment without departing from the true scope and spirit of the subject invention as defined in the claims.

FIG. 1—depicts a generalized block diagram of a portable gaming computer.

FIG. 1A—depicts a generalized block diagram of a tossable gaming object.

FIG. 1B—depicts a first form factor of a tossable gaming object.

FIG. 1C—depicts a second form factor of a tossable gaming object.

FIG. 2—depicts an embodiment of the invention where the tossable gaming object is wirelessly linked to one ore more portable gaming computers.

FIG. 2A—depicts another embodiment of the invention where the tossable gaming object is only linked to one of the portable gaming computers when in proximity to a localized electromagnetic field.

FIG. 2B—depicts another embodiment of the invention where the tossable gaming object is programmed to determine one or more projectile motion values.

FIG. 2C—depicts another embodiment of the invention where the tossable gaming object is encompassed in a flying disc.

FIG. 3—depicts a typical accelerometer response for a projectile measured as a function of elapsed time.

FIG. 3A—depicts a typical accelerometer response for a flying disc measured as a function of elapsed time.

FIG. 4—depicts a flow chart of an embodiment of the invention in which a tossable gaming object is in processing communications with a portable gaming computer.

### DETAILED DESCRIPTION

The invention provides a system, method and device for computer gaming which utilizes actual physical objects that are physically tossed rather than virtual computer generated objects that are merely tossed in simulation. Various embodiments of the invention allow one or more players to interact with the physical object using either active or passive telemetry techniques. The various embodiments of the invention include a portable gaming computer and an intelligent gaming peripheral device encompassed inside a tossable gaming object, for example a ball. The portable gaming computer is programmed to orchestrate game play and keep score without necessarily presenting simulated gaming action on a display screen. The gaming experience may be provided in single or multi-player embodiments; including the use of a single or multiple gaming peripheral devices; and maintaining individual or team scores depending upon the gaming program selected or encoded into the portable gaming computer and/or intelligent gaming peripheral device.

Where necessary, programs, algorithms and routines may be programmed in a high level language object oriented language, for example, Java™ C++, C#, C or Visual Basic™ or low level assembly language.

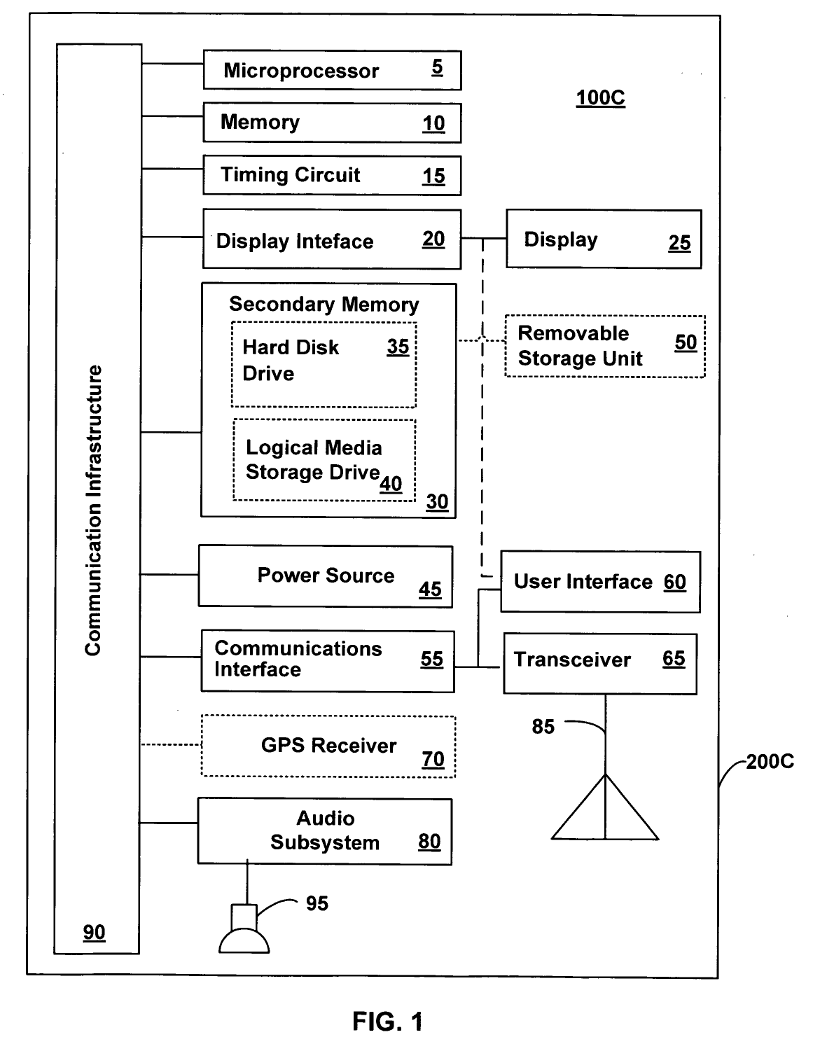

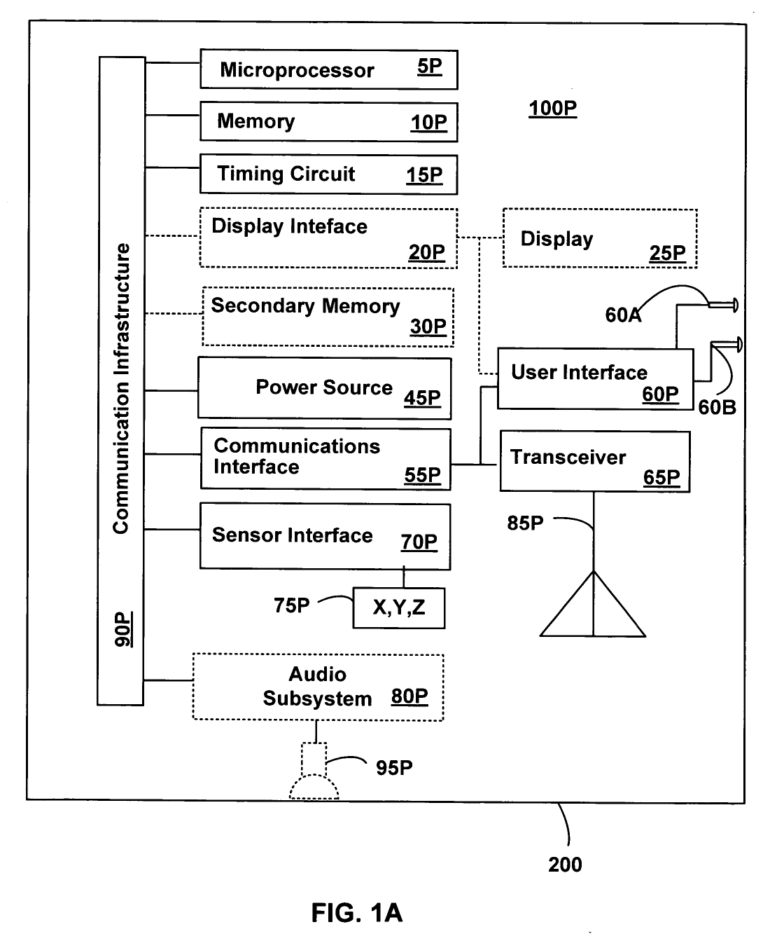

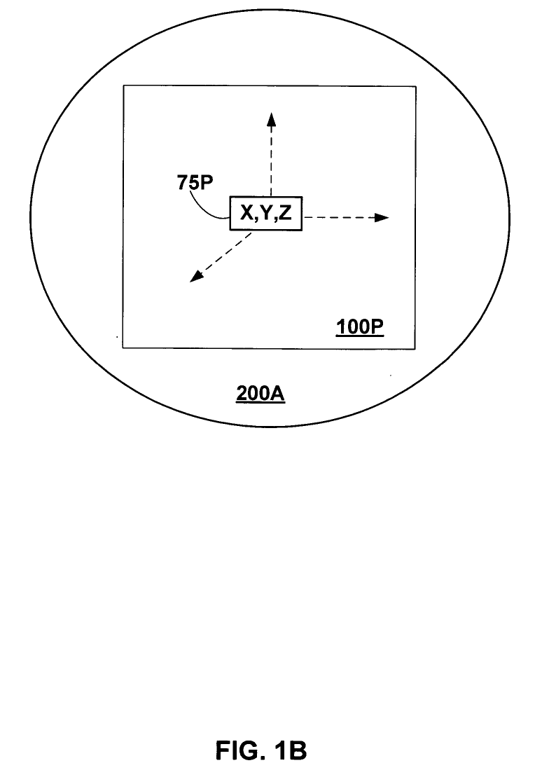

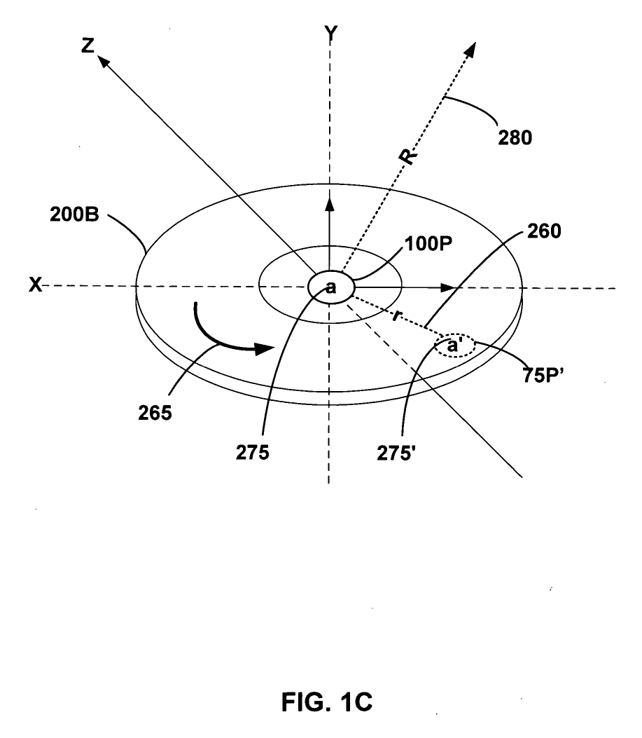

Referring to FIG. 1, a generalized block diagram of a portable gaming computer 100C is depicted. The portable gaming computer 100C includes a communications infrastructure 90 used to transfer data, memory addresses where data files are to be found and control signals among the various components and subsystems associated with the portable gaming computer 100C. A microprocessor 5 is provided to interpret and execute logical instructions stored in the memory 10. The memory 10 is the primary general purpose storage area for instructions and data to be processed by the microprocessor 5. The term “memory” 10 is used in its broadest sense and includes RAM, EEPROM and ROM. A timing circuit 15 is provided to coordinate activities within the portable gaming computer in near real time. The microprocessor 5, memory 10 and timing circuit 15 are directly operatively coupled to the communications infrastructure 90.

The microprocessor 5 is programmed with executable instructions to orchestrate game play in conjunction with input signals received from a player interface 60 and an internal transceiver 65. Game orchestration includes moderating, scorekeeping and officiating over game play.

A display interface 20 is provided to drive a display 25 associated with the portable gaming computer 100C. The display interface 20 is operatively coupled to the communications infrastructure 90 and provides signals to the display 25 for visually outputting both graphical displays and alphanumeric characters.

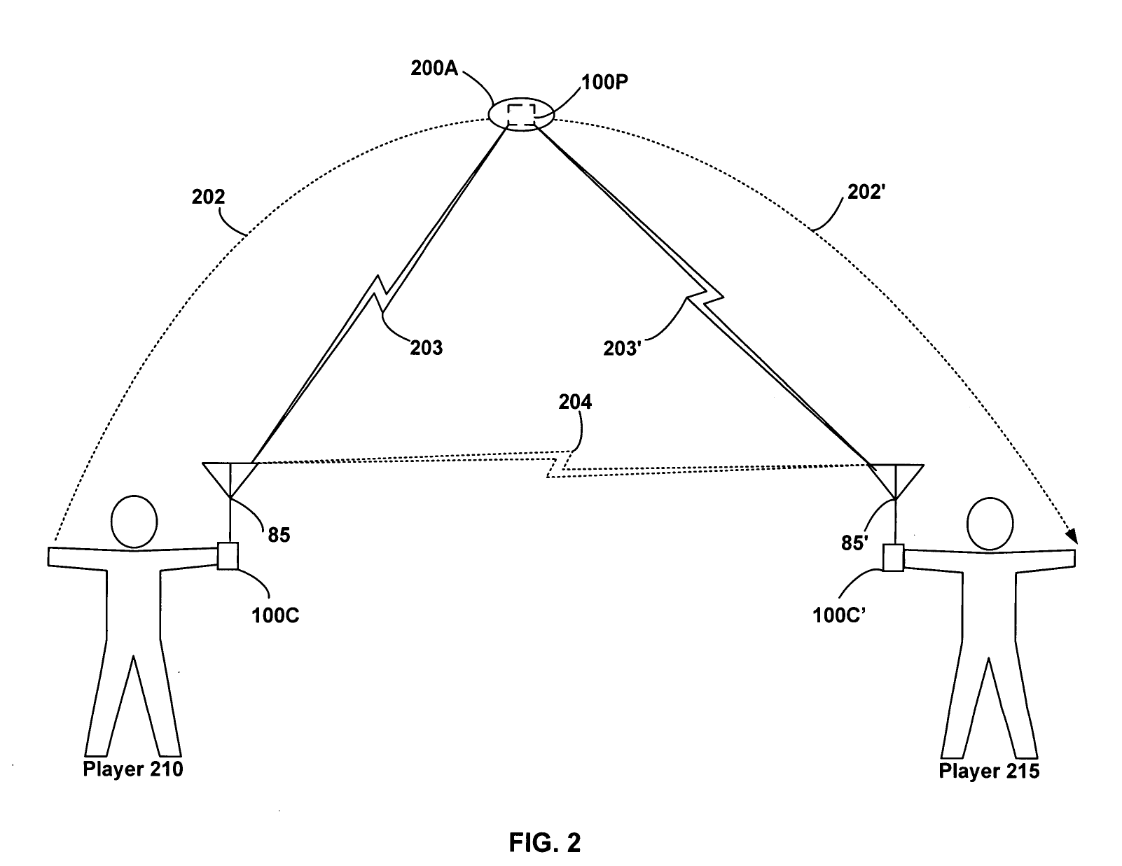

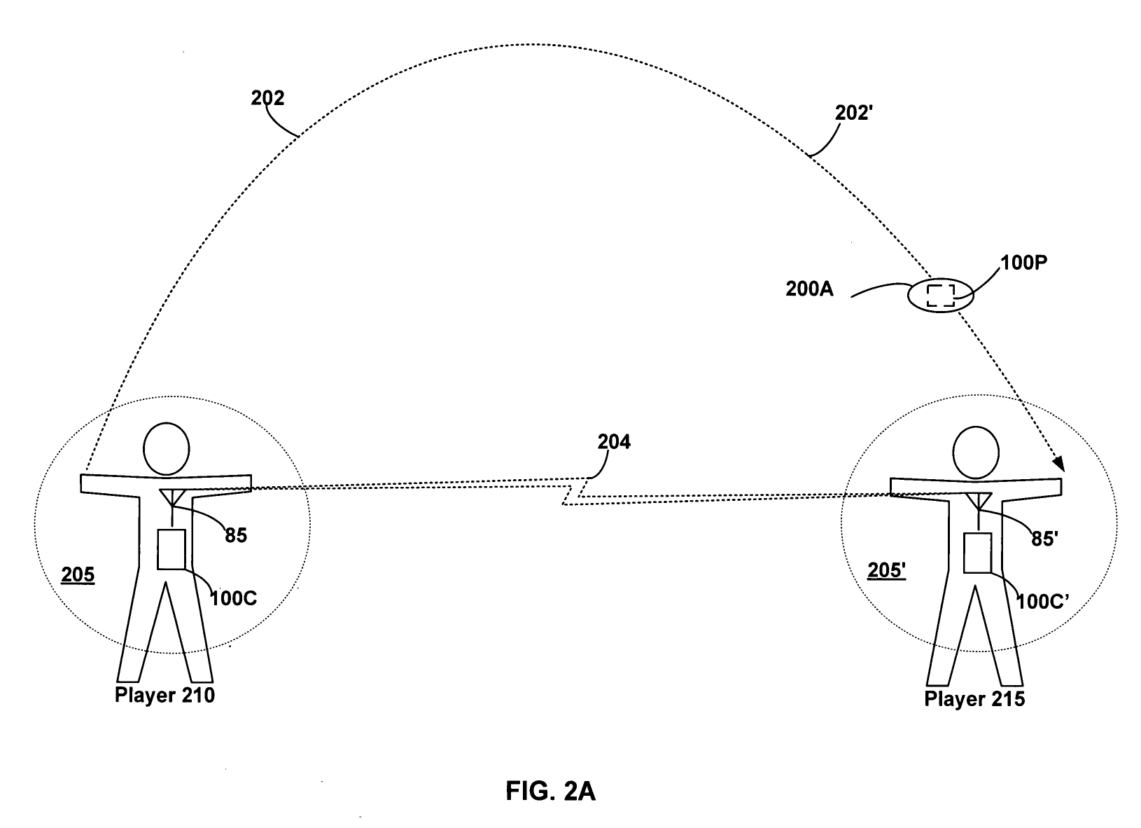

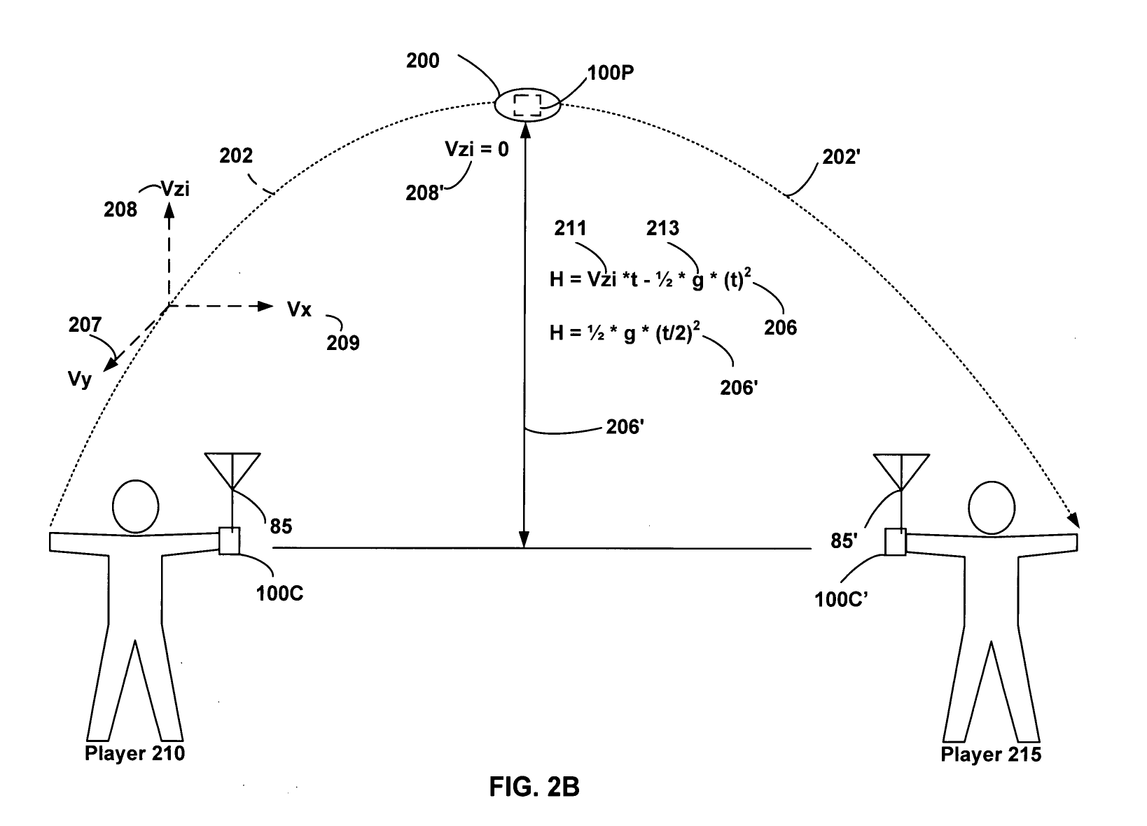

The display interface 20 may include a dedicated graphics microprocessor and memory to support the displaying of graphics intensive media. The display 25 may be of any type (e.g., cathode ray tube, gas plasma) but in most circumstances will usually be a solid state device such as liquid crystal display (LCD) and/or a combination of light emitting diodes (LED). In some embodiments the display 25 may be head mounted such that a player 210 (FIG. 2) can view information while keeping his or her hands free.

In an embodiment of a head-mounted display 25, the display 25 provides gaming information upon a semi-transparent screen such that a player may view the real physical world through the screen while simultaneously viewing gaming information overlaid upon and/or around the player's view of the real physical world. For example, the gaming score might be displayed as a small overlaid graphic upon the player's direct view of the real physical world.

A secondary memory subsystem 30 is provided which houses optional retrievable storage units such as a hard disc drive 35, a logical media storage drive 40 and an optional removal storage unit 50. One skilled in the art will appreciate that the hard drive 35 may be replaced with flash memory. The removable storage unit 50 may be used to update programs and data with new release versions.

The secondary memory 30 may store a variety of information related to game play. In some embodiments the secondary memory 30 stores digital audio files that may be retrieved and played to the player during game play, the digital audio files including background music and/or sound effects that may be selectively played to the player in coordination with certain detected gaming events.

An internal power source 45 such as a battery and/or photocell supplies electrical energy to operate the electrical circuits included in the portable gaming computer 100C.

A communications interface 55 is provided which allows for standardized electrical connection of peripheral devices to the communications infrastructure 90 including, serial, parallel, USB, and Firewire™ connectivity. For example, a player interface 60 and a transceiver 65 are operatively coupled to the communications infrastructure 90 via the communications interface 55. For purposes of this specification, the term player interface 60 includes the hardware and operating software by which a player interacts with the portable gaming computer 100C and the means by which the portable gaming computer 100C conveys information to the player and may include certain interactions with the display interface 20 and display 25.

The transceiver 65 facilitates the remote exchange of data and synchronizing of signals between the portable gaming computer 100C and the tossable gaming peripheral device 100P (FIG. 1A). The transceiver may also be used to communicate with other portable gaming computers 100C′ (FIG. 2) in coordinated game play.

In one embodiment of the invention, the transceiver 65 is envisioned to be of a radio frequency type normally associated with computer networks for example, wireless computer networks based on BlueTooth™ or the various IEEE standards 802.11x, where x denotes the various present and evolving wireless computing standards, for example WiMax 802.16 and WRANG 802.22. Alternately, digital cellular communications formats compatible with for example GSM, 3G, CDMA, TDMA and evolving cellular communications standards. Both peer-to-peer (PPP) and client-server models are envisioned for implementation of the invention. In a third alternative embodiment, the transceiver 65 may include hybrids of computer communications standards.

An antenna 85 is provided to transmit and receive radio frequency radiation. The antenna 85 may be configured as an internal wire loop, a fixed length external antenna (e.g., “rubber duckey”) or telescoping whip antenna.

In another embodiment of the invention, the transceiver 65 is configured as an RFID transceiver (scanner) for transmitting to an RFID chip 100P (FIG. 1A) encompassed in the tossable object 200 (FIG. 1A). In this embodiment, the transceiver transmits phase, pulse or frequency modulated signals, which if in sufficient proximity to the transceiver 65, energizes the RFID chip 100P causing the chip to transpond with an identification code colloquially known as a “barking bar code.” The identification code is then received by the transceiver 65.

In some embodiments, the RFID transceiver 65 may also be operative to program the RFID chip, causing data to be transmitted to the chip and stored within it. Such embodiment may be used, for example, to enable a portable gaming computer 100C to selectively program an RFID enabled tossable gaming object 200 thereby changing the gaming action.

The player interface 60 employed on the portable gaming computer 100C may include a pointing device (not shown) such as a mouse, thumbwheel or track ball, an optional touch screen (not shown); one or more push-button switches (not shown) one or more sliding or circular rheostat controls (not shown), one or more tactile feedback units (not shown), and one or more other type switches (not shown.)

The player interface 60 provides interrupt signals to the microprocessor 5 that may be used to interpret player interactions with the portable gaming computer 100C. Various embodiments of the invention may incorporate portions of the player interface 60 with the display interface 20 and display 25. One skilled in the art will appreciate that the player interface devices which are not shown are well known and understood.

An optional global positioning transceiver (GPS) 70 may be operatively coupled to the communications infrastructure 90 to provide geospatial information for use in various gaming implementations.

Lastly, an audio subsystem 80 is provided and operatively coupled to the communications infrastructure 90. The audio subsystem provides for the output of sounds corresponding to gaming instructions, voice output reciting the score or other game statistics, alert tones and sound effects to a game player. The sound effects may be programmed to correspond with a player's perceived physical motion of projectiles and other tossed objects to enhance the player's gaming experience.

For example, as a ball is thrown upward, the frequency of a sound effect may increase. This could provide a player with a sensory clue about the height the ball traveled, the speed of the ball, and/or the time until it will return to earth.

The audio subsystem includes a speaker output 95 or a headphone jack. Connection of a set of headphones 95 includes both traditional cable and wireless arrangements such as BlueTooth™ which are known in the relevant art.

The portable gaming computer 100C is envisioned to be encompassed within a highly portable housing 200C such as a palm-sized case or smaller form factor which may be held or worn by the player analogous to the various designs of, for example, the Apple iPod™.

In addition, the portable gaming computer 100C need not be a specialized piece of hardware, but may employ commercially available handheld gaming devices such as a Nintendo Gameboy™, personal data assistant (PDA) or a suitably equipped cellular telephone. The portable gaming computer 100C is also envisioned to be built into a wrist-watch and worn like a watch on the player's wrist during play or incorporated in a set headphones and/or suitably equipped eye glasses.

The portable gaming computer 100C includes an operating system, the necessary hardware and software drivers necessary to fully utilize the devices operatively coupled to the communications infrastructure 90, and programmatic instructions operatively loaded into the memory 10 to perform game orchestration in conjunction with player's interactions with player interface 60 and data received from the tossable gaming peripheral device 100P via the transceiver 65.

Additional programmatic instructions may be provided to perform data logging where the data collected from the tossable gaming peripheral device 100P may be stored for future analysis, replay, or downloading to other computers. This collected data could be used for educational purposes. For example, the tossable gaming peripheral device 100P encompassed inside a tossable gaming object 200 (FIG. 1A) may be used to illustrate projectile motion to physics students.

Other programmatic instructions may provide game status information, such as the current score of the game. Physical information including velocity, acceleration, transit time, peak altitude, catches, drops, misses, proximity to a goal and any other parameters useful for game play.

FIG. 1A provides a generalized block diagram of a first embodiment of the tossable gaming peripheral device 100P encompassed within a tossable gaming object 200A. One skilled in the art will appreciate that many of the components, circuits, interfaces and devices are equivalent to those described for the portable gaming computer 100C. In certain instances, abbreviated descriptions are provided to avoid duplicity and to simplify the understanding of the invention. In these instances, the description provided for the portable gaming computer 100C should be referred to.

No loss in inventive scope, functionality or flexibility in design is intended. The tossable gaming object 200 may be in the encompassed in various form factors including a ball 200A or a disc 200B as shown in FIGS. 1B, 1C and 1D. For simplicity and ease of understanding, the tossable gaming object 200 may be referred to interchangeably as the ball 200A or disc 200B.

The tossable gaming peripheral device 100P includes a communications infrastructure 90P, a microprocessor 5P, a memory 10P and a timing circuit 15P. The microprocessor 5P, memory 10P, timing circuit 15P and communications infrastructure 90P may be integrated into a common chip for space and electrical power savings as well as improved ruggedness.

The microprocessor 5P is programmed with executable instructions to process sensor signals 75P received from a sensor interface 70P and transmit the processed sensor signals via an internal transceiver 65P to a portable gaming computer 100C.

An optional display interface 20P may be provided to drive an optional display 25P. The optional display interface 20P and display 25P are generally provided in tossable gaming objects 200A not anticipated to be used in conjunction with force multiplying devices such as a baseball bat or tennis racket.

However, the use of flexible organic display screens or LEDs may be used to replace traditional LCD displays 25P for use with the force multiplying devices.

Where applicable, the microprocessor 5P may further be programmed to perform game play in conjunction with input signals received from a player interface 60P via simple push button switches 60A, 60B and output information to a player on the display 25P.

An optional secondary memory 30P may be provided in embodiments of the invention where data storage and greater programming flexibility are desirable. For example, where the tossable gaming peripheral device 100P is performing time integration functions and/or processing multiple sensor inputs, a secondary memory 30P may be necessary to avoid overflowing the primary memory 10P.

An internal power source 45P such as a battery, and/or photocell supplies electrical energy to operate the electrical circuits included in the tossable gaming peripheral device 100P. In some embodiments an inertial power generation system is employed within the tossable gaming peripheral device 100P to generate power in response to the physical motions induced upon it by a player 210.

A communications interface 55P is provided which optionally provides for direct electrical connection of the tossable gaming peripheral device 100P to the portable gaming computer 100C or another computer system. A simplified player interface 60P and a transceiver 65P are operatively coupled to the communications infrastructure 90P via the communications interface 55P.

The transceiver 65P facilitates the exchange of data and synchronizing signals between the tossable gaming peripheral device 100P and one or more portable gaming computers 100C, 100C′. The transceiver 65P is of a type compatible with the transceiver 65 provided for the portable gaming computers 100C, 100C′ (FIG. 2.) An internal antenna 85P is provided to transmit and receive radio frequency radiation in conjunction with the one or more portable gaming computers 100C, 100C′.

In another embodiment of the invention, the transceiver 65P is actually a low power device with little or no data receiving capability. In this embodiment of the invention, the tossable gaming peripheral device 100P acts simply as a remote transponder.

A sensor interface 70P is provided which allows one or more sensors 75P to be operatively coupled to the communications infrastructure 90. The sensor interface 70P may monitor interactions with the player interface 60P.

Another function of the sensor interface 70P is to determine the various dynamic states in which the tossable gaming peripheral device 100P may be undergoing. For example, static state (no movement), time of release, time of catch, flight time, a throw, a drop or a miss based on signals received from the one or more sensors 75P.

In a further example, the sensor interface 70P may be used to monitor a player's interaction with the one or more push-button switches 60A, 60B. Alternately, the push-button switches 60A, 60B may be augmented or replaced with capacitive sensing circuits (not shown) and/or other touch sensitive type circuitry (not shown) known in the relevant art. A separate interrupt circuit (not shown) may be incorporated into the hardware supporting the communications infrastructure 90, sensor interface 70P, player interface 60P, and/or an optional audio subsystem 80P.

The one or more sensors 75P operatively coupled to the sensor interface 70P include single and multi-axis accelerometers 75P, a proximity antenna 85P, an inclinometer, a momentary switch, an altimeter, a timer and a GPS receiver 75P. An integrating circuit (not shown) may be operatively coupled to the accelerometers 75P and timing circuit 15P to provide velocity and distance information. The advantage of a GPS receiver 75P is that the receiver provides actual position and velocity. Alternately, or in conjunction with the accelerometers 75P, the GPS receiver 75P may be used to determine geospatial location, displacement, velocity and altitude. Accelerometers are preferred in implementations where ruggedness and costs are of primary consideration.

Accelerometers 75P are generally low in cost and may be configured or selected to determine instantaneous and/or average accelerations acting upon a tossable gaming object 200 in which it is incorporated into.

The optional audio subsystem 80P and internal speaker 95P may be provided to supplement or replace the optional audio subsystem described for the portable gaming computers 100C. The audio subsystem 80P may further be programmed to emit periodic tones for locating a lost tossable gaming object 200. Alternately, or in conjunction therewith, the transceiver 65P may be programmed to periodically transmit to provide “fox-hunting” games and/or locating a hidden or lost tossable gaming object 200.

In another simple embodiment of the invention, the tossable gaming peripheral device 100P is an RFID chip encompassed within the tossable gaming object 200.

In this simple embodiment of the invention, the microprocessor 5P, memory 10P, transceiver (i.e., transponder) 65P and communications infrastructure 90P are integrated into a single chip in which a wire loop antenna 85P is connected.

In some embodiments of the invention, the RFID chip 100P within the tossable gaming object 200 is passive, drawing all power from an appropriate RF signal emitted by the portable gaming computer 100C. In other embodiments the RFID chip 200 is active, drawing power from a battery or other power source on board the tossable gaming object 200. The advantage of an active RFID chip 100P is that it can be generally be detected from a longer range by a portable gaming computer 200C than a passive RFID chip 100P.

In the RFID embodiment of the invention, gaming operation of the tossable gaming peripheral device 100P is provided by proximity to a properly encoded RF signal. For example, a portable gaming computer 100C equipped with RFID scanning capability may be configured to detect when an RFID chip 100P equipped tossable gaming object 200 is present within a certain proximity of the portable gaming computer. Various other implementations of the RFID chip 100P embodiment may utilize Doppler shift phenomenon to provide telemetry information as determined by the received transponder signal using the portable gaming computer 100C. In some embodiments the RFID chip 100P may only be read by an RF scanning capability of the portable gaming computer 100C (i.e. data may be read from the memory of the RFID chip 100P by the portable gaming computer 200C). In other embodiments the RFID chip 100P may also be written to by an RF writing capability of the portable gaming computer 200C (i.e. data may be sent by the portable gaming computer and stored in the memory of the RFID chip 100P.)

In all embodiments of the invention, placement of the electronics comprising the tossable gaming peripheral device 100P within the tossable gaming object 200 are generally placed close to the geometric center to prevent imbalances and erratic flight characteristics, and/or are sufficiently counterweighted to prevent imbalance

Referring to FIG. 1B, a ball 200A form factor embodiment of the tossable gaming object 200 is depicted. In this embodiment of the invention, a traditional ball 200A which has been modified to include the electronics comprising the tossable gaming peripheral device 100P is provided for outdoor play. The ball 200A may be tossed, caught, bounced, hit, kicked, struck, etc. to produce the dynamic event(s) detectable by the one or more sensors 75P. For example, the ball 200A may be in the form of a resilient rubber hand-sized ball for playing catch. In a simple embodiment of the invention, the one or more sensors 75P described above are accelerometers for detecting the acceleration of the ball 200A. The accelerometer 75P may be a single axis accelerometer that detects acceleration along one degree of freedom or may be a multi-axis accelerometer 75P that detects acceleration along multiple degrees of freedom. In some common embodiments, the accelerometer 75P is a three axis accelerometer that detects acceleration in three orthogonal degrees of freedoms commonly referred to as X, Y, and Z. A single vector resultant of the multiple acceleration signals may be processed by the electronics of the present invention or each directional component may be individually processed. The acceleration information may be processed locally, partially processed locally or provided as raw information and sent over a wireless communications link to the portable gaming computer 100C during game play.

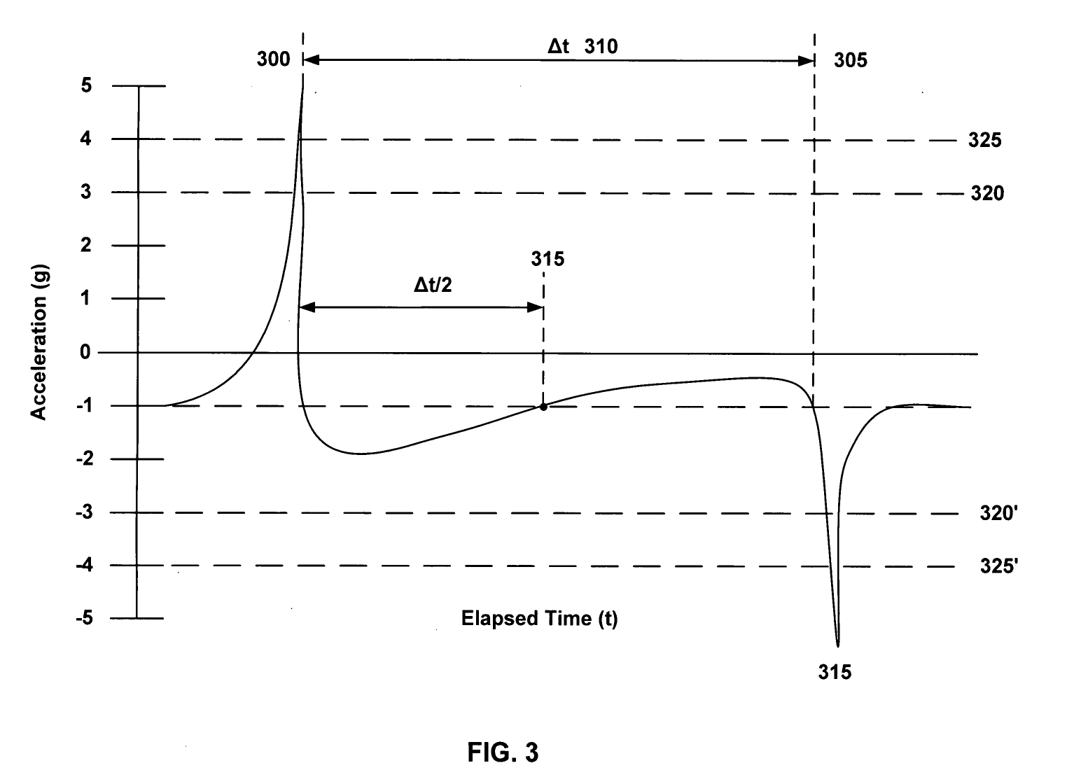

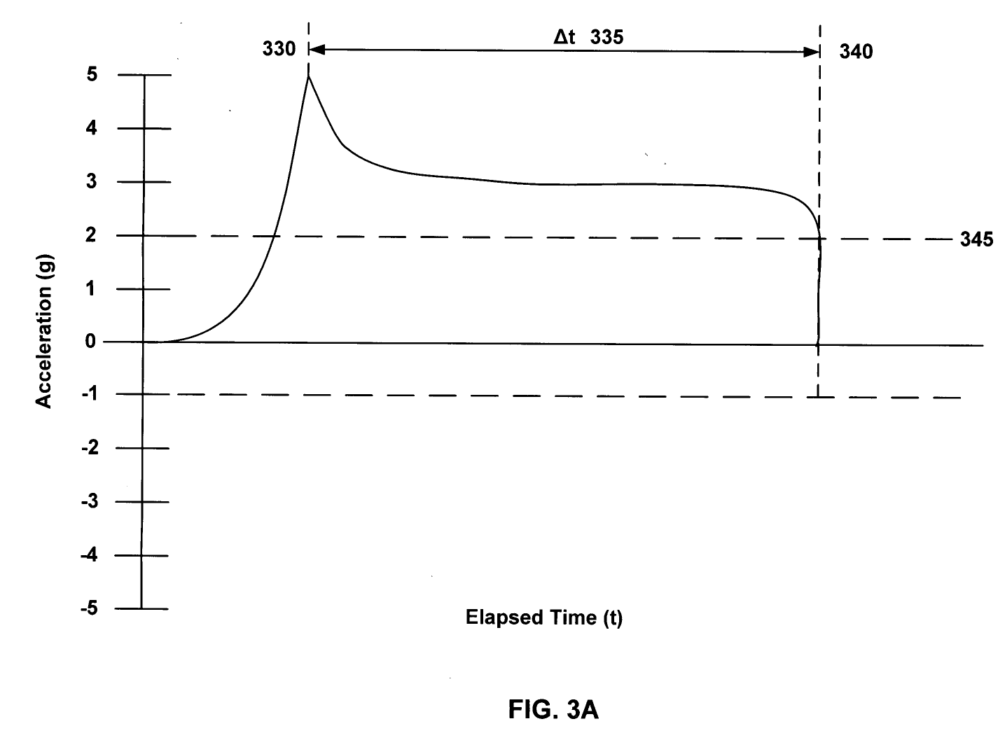

The portable gaming computer 100C, is programmed to process the received acceleration information to determine if the ball 200A has been thrown, caught, bounced, rolled, etc., based on the dynamic event's characteristic acceleration impulse information (FIG. 3.)

When a single axis accelerometer 75P is used, a gimbal mount that is offset weighted may be employed such that the accelerometer 75P automatically orients itself in a vertical direction with respect to gravity as a result of the offset weighting. In this way the single axis accelerometer 75P is generally oriented along the vertical axis regardless of how the ball gaming object may tumble in the air. The gimbal mount of a single axis accelerometer may have certain cost advantages over more sophisticated multi-axis accelerometers. However, depending upon the sensing requirements of the particular application and dynamic events that are detected, a multi-axis accelerometer 75P may be preferred. Also a multi-axis accelerometer 75P may be used to gain orientation information with respect to the earth by detecting direction of the acceleration due to gravity (which always points vertically downward). In some embodiments a GPS receiver 75P may be used within the tossable gaming peripheral device 100P to provide even more detailed telemetry information.

The elapsed time between the first (throw) dynamic event and the second (catch, drop or miss) dynamic event is determined to approximate the flight time Δt 310 of the ball 200A. It is envisioned in an embodiment of the invention that a simple time integration circuit (not shown) may be provided and operatively coupled to the accelerometer 75P and timing circuit 15P to determine the ball's 200A velocity during game play. Once the velocity of the ball 200A has been determined, the flight time Δt 310 of the ball 200A could be used to calculate the overall distance the ball 200A has traveled by simply multiplying the X axis velocity Vx 209 (FIG. 2B) by the flight time Δt 310. Likewise, since velocity has magnitude and direction components, the relative bearing of the ball 200A to its point of origin may be determined by vector analysis.

If a three axis type accelerometer and/or a GPS transducer 75P is employed as a sensor 75P in the ball 200A, the portable gaming computer 100C may be programmed to determine if the ball 200A was thrown straight up at a very high trajectory angle and subsequently caught, dropped or directly impacted the ground.

Alternately, or in addition thereto, the portable gaming computer 100C may be programmed to determine if the ball 200A was thrown across a field in a more parabolic trajectory and subsequently caught by a second player, dropped or directly impacted the ground.

In an alternate embodiment of the invention, the ball 200A may incorporate the portable gaming computer 100C within, thereby not requiring any communication link. In this inventive embodiment, as well as in the previous embodiments, the ball 200A may include the display and/or light emitting diodes 25P, and/or the audio subsystem 80P, 95P for outputting information to one or more game players.

Another form factor is provided in the shape of a flying disc as is shown in FIG. 1C. In this embodiment of the invention, a traditional flying disc 200B is used for outdoor play. For example, a Frisbee™, may be modified to encompass one or more embodiments of the tossable gaming peripheral device 100P described above. The flying disc 200B presents a number of unique issues as compared to simple projectiles since there is far less cross-sectional volume to incorporate the tossable gaming peripheral electronics 100P and the disc 200B is actually flying due to aerodynamic lift.

In addition, the placement and the type of sensors 75P and/or counterweights must be more carefully selected to maintain a generally uniform weight distribution; otherwise the flying disc 200B will be unbalanced and fly erratically.

To prevent an unbalanced situation from occurring, the electronics comprising the gaming peripheral device 100P are located at the center of the disc 200B and/or are sufficiently counterweighted to ensure the center of mass of the system is substantially located at the center of rotation of the disc. In one embodiment of the invention, the dynamic event sensor 75P is co-located in the center with the electronics comprising the gaming peripheral device 100P. However, when the dynamic event sensor 75P is an accelerometer, locating the dynamic event sensor 75P in the center of the disc 200B is not necessarily preferred.

In an alternate embodiment of the invention, a single axis accelerometer 75P is used as the dynamic event sensor 75P′ and is positioned some radius r 260 away from the center and oriented such that the accelerometer 75P sensing axis is oriented along a radius of the disc. Because of this positioning, it will rotate quickly about the center of the disc when the disc is tossed. This is because a flying disc rotates rapidly when in normal use (i.e. when properly tossed).

Since the accelerometer sensor 75P′ is displaced from the center and is rotating rapidly about the center when in flight, centripetal forces a′ 275′ cause the accelerometer 75P′ to sense an outward resultant acceleration force generated by the rapid rotation of the flying disc 200B. The magnitude of this acceleration is a function of the rotational speed 265 of the disc 200B; By detecting the changing magnitude of this acceleration, the electronics 100P of the present invention may detect and differentiate the dynamic events imparted upon the disc by the player 210, including the dynamic events of a throw, a catch, a drop, a miss, a tip and an impact with a solid object such as the ground or disc golfing target based on the accelerometer's characteristic acceleration impulse information (FIG. 3A.) However, if information beyond the simple dynamic events of throw, catch, drop, miss, tip and an impact with a solid object are desired, a more sophisticated multi-axis accelerometer and/or GPS receiver 75P embodiments may be employed. In some embodiments of the flying disc 200B version of the invention, counterweights (not shown) may be required to offset any imbalances introduced by placing the accelerometer (and/or other components) away from the center of the disc 200B. Placement of a GPS receiver type sensor 75P is ideally located at the center of the disc 200B. The GPS receiver type sensor 75P can provide actual velocity and distance information.

In the accelerometer sensor 75P embodiments of the invention, the portable gaming computer 100C is programmed to determine if the flying disc 200B has been thrown, caught, hit the ground, or collided with a solid object, based on the characteristic acceleration impulse magnitudes (FIG. 3A) associated with each of the above listed dynamic events.

In addition the acceleration data a 275 may be integrated to estimate and/or determine the flying disc's 200B spin velocity during game play. This information may be used by the portable gaming computer 100C to estimate how hard the flying disc 200B has been thrown by a player 210.

As noted above for the ball embodiment 200A, the elapsed time Δt 335 between a first dynamic event (throw) and a second dynamic event (catch, miss, tip, etc.) would be the flight time Δt 335 of the flying disc 200B.

In this embodiment however, the flight time Δt 335 may not be a direct indication of overall distance traveled as the flight characteristics of flying disc 200B are dependent on numerous factors including gravity, the amount of angular momentum imparted to the disc, the amount of forward momentum imparted upon the disc, and the amount of lift generated during flight. However, rough estimates of distance may be generated based upon flight time Δt 335 and acceleration levels.

In another embodiment of the flying disc 200B invention, the RFID embodiment of the invention may be incorporated into the flying disc 200B form factor. The RFID embodiment of the invention functions nearly identically to that described for the ball form factor 200A and is not discussed separately. This is because the RFID 100P embodiments operate based upon proximity detection rather than detection of motion dynamics and therefore do not need to address the differences in motion dynamics between a disc 200B and a ball 200A.

Referring to FIG. 2, an exemplary embodiment of the invention is depicted where a simple game of catch is played. A first player 210 throws a tossable gaming object 200A, for example, a football, to a second player 215. The tossable gaming peripheral device 100P monitors one or more of the dynamic forces acting on the tossable gaming object 200A including acceleration, time of throw by the first player 210, time of the peak of the ball's parabolic trajectory, and time of the catch or impact with the ground using one or more of the sensors 75P described above.

The internal microprocessor 5P processes the sensor signals and transmits 203, 203′ a representation of the timing, dynamics events, and/or resulting telemetry to the portable gaming computer 100C, 100C′ held by the players 210, 215.

In a further embodiment of the invention, the portable gaming computers 100C, 100C′ may be in direct wireless communications 204 to orchestrate game play and exchange information such as the current number of throws, number of catches, number of drops, flight time Δt 310 achieved, catch impact level, distance traveled, velocity of the ball, peak altitude, peak acceleration, etc.

The two portable gaming computers 100C, 100C′ in the example provided above may independently track game action, or may be synchronously operated using the wireless link 204 to ensure both units are coordinated in how the game is being orchestrated and scored. In another embodiment of the invention, the tossable gaming peripheral device 100P be programmed to allow the 202, 202′, 204 receiving of configuration data from either or both of the portable gaming computers 100C, 100C′.

The invention is intended to be sufficiently flexible to allow multiple tossable gaming peripheral devices 100P to be simultaneously interfaced to one or more portable gaming computers 100C, 100C′ and visa versa. This arrangement allows for gaming paradigms that employ multiple projectiles (i.e., multiple balls, discs, or moving players) at the same time. When multiple tossable gaming peripheral devices 100P are used; each peripheral device may be assigned a unique peripheral ID for identification and communication with a portable gaming computer 100C and/or other tossable gaming peripheral devices 100P in the field of play.

For example, each tossable gaming 200 may be encoded with a unique ID number or code that is stored in a memory 15P local to the peripheral. The portable gaming computers 100C of the present invention may then detect and process the unique identifiers stored within each of a plurality of tossable gaming peripheral devices 100P and thereby distinguish between them during game play.

Likewise, when multiple players 210, 215 are playing simultaneously; each player may be assigned a unique player ID for identification and communication with the portable gaming computers 100C, 100C′ and/or the other players.

Another embodiment of the invention is depicted in FIG. 2A. In this embodiment of the invention, the tossable gaming peripheral device 100P is a simple RFID chip 100P encompassed in the tossable gaming object 200A (football.) An RFID transceiver 65 is encompassed within and/or interfaced to the portable gaming computer 100C and 100C′. The portable gaming computers 100C, 100C′ are thereby configured to access the RFID chip 100P when the chip is within certain proximity of each portable gaming computer 100C′, 100C′. In this exemplary embodiment, the RFID chip transponds when it is within the RF field 205 generated by the first players' 210 portable gaming computer 100C, but does not transpond when outside the RF field 205. Similarly, the RFID chip 100P transponds when it is within the RF field 205′ generated by the second players' 215 portable gaming computer 100C′, but does not transpond when outside the RF field 205′. In this way, each portable gaming computer may be configured in hardware and software detect whether or not the tossable gaming peripheral device 100P is then currently proximal to the respective player of that portable gaming device.

Thus during a first duration in time, player 210 may be holding the ball 200A and preparing to throw it. During this duration, player 210's possession of the ball 200A is detected by software executing in the portable gaming computer 100C of the present invention as a result of the RFID chip 100P transponding over the duration (i.e. sending data to portable gaming computer 100C). Then at some point in time, player 210 throws the ball 200A. Almost immediately upon being thrown, the ball 200A leaves the RF field 205 and ceases to transpond (i.e. ceases to send data to portable gaming computer 100C). The loss of the transponder signal is used by portable gaming computer 100C as an indication that the ball 200A was thrown for it is no longer proximal to player 210.

The loss of the transponder signal causes a throw counter to increment in the first players' 210 portable gaming computer 100C, indicating that the football 200A has been thrown 202. When the football 200A enters the proximity of the RF field 205′ generated by the second players' 215 portable gaming computer 100C′, the transponder associated with the RFID chip 100P is again actuated. The receipt of the transponder signal causes a catch counter to increment in the second players' 215 portable gaming computer 100C′, indicating that the football 200A has been caught 202′. The process is repeated for each consecutive throw/catch cycle. At the same time, portable gaming computers 100,100C may communicate timing data over wireless communication link 204 such that the time of flight between the detected throw and the detected catch may be determined by one or both of the portable gaming computers 100C, 100C′.

In some embodiments a catch is determined as a result of the received transponder signal being detected for more than a certain threshold amount of time. This is because a missed ball 200A will sometimes pass through the RF field 205, 205′ and then hit the ground but a caught ball 200A will be held proximal to the player 210, 215 for more than the threshold amount of time. Thus a catch can be distinguished from a miss by the present invention as a result of detecting a received transponder signal for more than a threshold amount of time. A threshold of 2500 to 3500 milliseconds is often effective. The threshold is generally subtracted from the computed time of flight Δt 310 such that it is not artificially added to the flight time Δt 310 as a result of the threshold limit process

Since each RFID chip 100P provides a unique identification code, the 215 portable gaming computers 100C, 100C′ may be programmed to only respond to a recognized tossable gaming peripheral device 100P. In a further embodiment of the invention, the first and second player's 210, 215 portable gaming computers 100C, 100C′ are in processing communications over a wireless link 204.

Referring again to FIG. 2A, the portable gaming computer 100C is attached to a belt of the player 210 and emits an RF field 205 centered about the portable gaming computer 100C. The RF field 205 would have a radius, for example, of approximately 1 meter. An approximately 1 meter RF field would allow most players of average size to maintain their hands, even with arms extended within the RF field 205. Thus, if a ball 200A is held by the player, the portable gaming computer 100C will detect the ball 200A.

When a player tosses the ball 202, the transponder signal is lost at the first portable gaming computer 100C. When the transponder signal is detected by the other portable gaming computer 100C′, the ball 200A may be assumed to have been caught by the second player 215. If the ball 200A is momentarily detected but is again lost, the ball 200A may be assumed to have been dropped or missed. Alternately, if the ball 200A is not seen for more than a certain amount of time (e.g, 5 seconds) it may be assumed that the ball 200A was missed entirely. The wireless link 204 may be used to determine whether the football 200A has been caught or dropped based on elapsed time measurements.

In addition, if the portable gaming computers 100C, 100C′ are suitably equipped with GPS receivers 70 or other sensors 75C, or the distance between the players is known, additional information may be determined such as velocity of the ball, peak altitude, peak acceleration, flight time, etc.

In some embodiments, a player 210, 215 may play catch by his or herself, for example tossing the ball 200A up and catching it. The portable gaming computer 100C in such an embodiment may award points, for example, based upon the number of consecutive catches and/or based upon the achieved flight time Δt 310 and/or toss height. In such an embodiment an adapted version of FIG. 2A may be employed in which only a single player 210 and a single portable gaming computer 100C are included. In such an embodiment the single gaming computer 100C detects both the toss and the catch using the same RF proximity methods described previously.

The single computer 100C may be programmed to count the number of consecutive catches, determine the maximum flight time achieved, and/or determine maximum height achieved by the player, and thereby provide a gaming scenario.

The calculation of the various flight parameters is described in FIG. 2B. The football 200A used in the previous examples is assumed to follow Sir Isaac Newton's laws of projectile motion where the maximum height H 206′ a projectile will achieve is the product of the projectile's initial vertical velocity Vzi 208 and time of flight t 211 less the product of ½ the gravitational constant g 212, (9.8 m/sec²) and the square of the time of flight t 211 as provided in the equation 206 shown below.
H=Vzi*t−½*g*(t)²

A football 200A thrown from one player 210 to another 215 follows a parabolic trajectory due to the influence of gravity pulling the football 200A back to earth. The parabolic trajectory 202,202′ includes both a vertical Vz 208 and horizontal Vx 209 component. When the vertical component Vz 208′ reaches zero (0) due to the earth's gravitation attraction, the football 200A has reached its maximum height and the basic projection motion equation is reduced to the equation 206′ shown below.
H=−½*g*(t/2)²

The time of flight t 211 is divided in half to determine the time the football 200A reached its maximum height H 206′.

FIG. 3 depicts an exemplary accelerometer flight profile for a tossable gaming object 200 encompassed in a projectile such as a ball 200A. FIG. 3 shows a profile of vertical acceleration with respect to time. The figure shows both positive and negative values, although in some embodiments an absolute acceleration value may be used where only the magnitude of the accelerations and not the sign (positive or negative) is considered when determining dynamic event state. The accelerometer 75P used in the tossable object may be configured in a variety of ways. For example, the accelerometer 75P may be a single axis accelerometer 75P mounted upon a gimbal such that it is always points substantially downward as described previously, or may be a three axis accelerometer that reports a vector resultant value as also described previously. In either case, the accelerometer is configured to detect a rapid positive acceleration of the ball 200A as it is thrown 300.

Minor accelerations caused by handling may be filtered out by a discriminator circuit (not shown) and/or by software filtering such that only those signals exceeding a threshold value, for example, a change of plus or minus 3 g's 320, 320′, will result in a impulse signal to be sent for processing. As shown in the figure, the vertical acceleration profile ramps up quickly as the player begins the throwing motion of the ball and then decays rapidly after release of the ball at 300. The vertical acceleration drops to a value slightly less than −1 g due to the effect of gravity combined with air resistance. As the ball slows, the air resistance effect is reduced and the acceleration value approaches −1 g in the vertical direction (i.e. the effect of gravity).

This occurs as the ball 200A nears its peak height in its parabolic trajectory because that is the moment in time when vertical velocity drops to 0. As the ball 200A starts coming back down, the vertical velocity increases, causing air resistance to mount once again. As a result the vertical acceleration rises slightly over time away from −1 g as shown. When the ball is caught 305 or impacts the ground 320 the sudden deceleration causes a large impulse signal 315 which is sent for processing.

The impulse signal is expected to be somewhat less in magnitude for a ground impact 320′ than for a catch 315 because a person catching a ball 200A generally cushions the impact. Thus the magnitude of the impulse may be used by the software of the present invention to distinguish between a catch and a miss. The elapsed time between the threshold exceeding throw impulse at 300 and the threshold exceeding catch (or miss) impulse at 305 is approximately equal to the time of flight Δt 310 of the ball. The peak height 315 of the parabolic trajectory occurs at approximately ½ the elapsed time of flight Δt 310. The peak height may be computed by the software of the present invention using the equation described previously, H=−½*g*(t/2)² 206′.

FIG. 3A depicts an exemplary accelerometer flight profile for a tossable gaming object 200A encompassed in a flying disc with a single axis accelerometer mounted away from the center, for example at 75P′ in FIG. 1C. As described above, the accelerometer detects a rapid positive acceleration as the disc 200B is thrown 330 as a result of the spinning of the disc 200B inducing centripetal acceleration.

As before, minor accelerations caused by handling may be filtered out by a discriminator circuit (not shown) and/or software filters such that only those impulse signals exceeding a threshold value, for example 2 g's 345, will result in an impulse signal being sent for processing. The acceleration profile for a flying disc 200B rises quickly as a player begins to throw the disc 200B. It then drops down slightly upon release at 330 and decays slowly during flight as the rate of spinning slows gradually due to air resistance. A positive acceleration is signal is provided due to the constant acceleration caused by the rotation of the disc 200B.

When the disc is caught 340 or impacts the ground the sudden ceasing or slowing of the spinning of the disc 200B causes a rapid decay in detected acceleration to approximately zero g's which is detected by the accelerometer and sent for processing. The elapsed time between the threshold exceeding throw acceleration 330 as the disc is tossed and the sudden deceleration 340 as the disc 200B is stopped (either caught or impacting the ground) is approximately equal to the time of flight Δt 335.

A flying disc 200B does not strictly obey the laws of projectile motion as the disc 200B is actually flying rather than free falling body. Because the disc 200B will more rapidly cease its spinning upon being caught as compared to hitting the ground, the rate at which the acceleration drops to zero at 340 may be used by the gaming software executing in the portable gaming computer 100C to distinguish between a catch and a miss. For example, an acceleration profile that very quickly drops to zero at 340 is determined to be a catch while an acceleration profile that more gradually drops to zero at 340 is determined to be a miss.

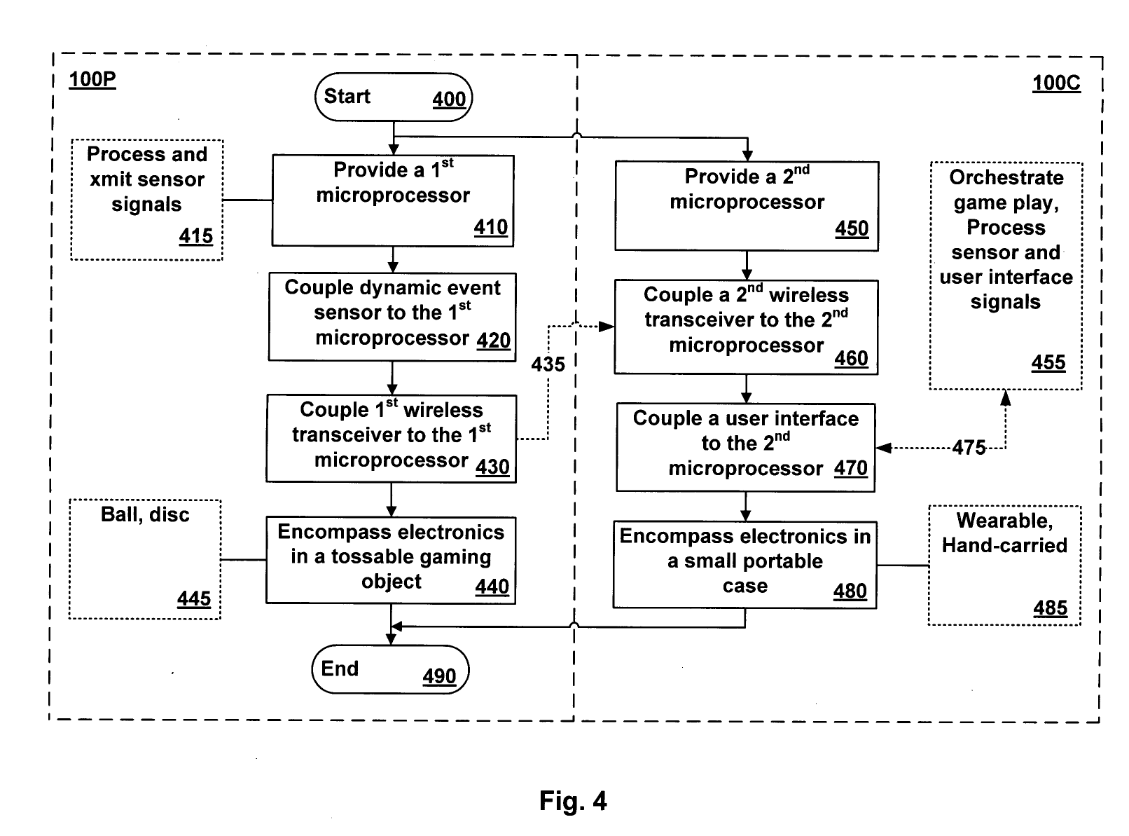

Referring to FIG. 4, a first process is depicted for providing a tossable gaming peripheral device 100P embodiment of the invention. The process is initiated 400 by providing 410 a first microprocessor 5P programmed to process and transmit sensor signals 415; coupling 420 a dynamic event sensor 75P to the first microprocessor 5P; coupling 430 a first wireless transceiver 65P to the first microprocessor 5P; and, encompassing 440 the first microprocessor 5P, dynamic event sensor 75P and first transceiver 65P in a tossable gaming object 200; where the tossable gaming object includes a ball 200A or a flying disc 200B thus completing the first process 490.

In conjunction with or in addition thereto, a second process is depicted for providing a portable gaming computer 100C embodiment of the invention.

The process continues from the first process by providing 450 a second microprocessor 5 programmed to orchestrate game play 455, process sensor signals transceived 435 from the first microprocessor 5P and process player interface signals 475 received from a player interface 60; coupling 460 a second wireless transceiver 65 to the second microprocessor 5; coupling 470 a player interface 60 to the second microprocessor 5; and, encompassing the second microprocessor 5, second wireless transceiver 65 and player interface 60 in a small portable case 200C; where the case 200C may be wearable or hand-carried 485; thus completing the second process 490.

### Computer Orchestrated Games

The following examples are provided to illustrate some types of games which may be orchestrated using the portable gaming computer 100C and the various gaming peripheral devices 100P described above. The examples provided below are not intended to be all inclusive. One skilled in the art will appreciate that a multitude of games may be devised for use with invention and no limitation in the scope of the invention is intended by the examples provided below.

CATCH: The simplest and most basic game played by kids worldwide with a projectile plaything is “catch”. Kids can spend hours throwing a ball 200A back and forth, or a flying disc, or some other projectile. With a suitably equipped ball 200A or flying disc 200B, the simple game of catch can become a computer orchestrated experience that has added fun and complexity.

In the current example, consider the following configuration, although other configurations are possible: The portable gaming computer 100C is a hand-held computer programmed with a multitude of “catch” games. The gaming peripheral device 100P is a ball 200A, equipped with one or more accelerometer sensors 75P that can detect instantaneous acceleration of the ball 200A and convey such information to the portable gaming computer 100C by a wireless data link 202, 202′.

Based upon the characteristic profile of the received acceleration data, the portable gaming computer 100C is programmed to determine if the ball 200A has been thrown by a player, caught by a player, or bounced off the ground, and the relative magnitude of each dynamic event.

The portable gaming computer 100C may also be programmed to determine the basic projectile motion of the ball 200A as it is thrown very high, reaching its peak altitude against the downward force of gravity and then accelerating back down to earth. Based upon these programmatic determinations, a variety of computer orchestrated enhancements to game play can be implemented using the portable gaming computer 100C.

BASIC-CATCH: Using the processed data determinations described above, the portable gaming computer 100C may be programmed to keep basic score of a two player 210, 215 catch game; counting how many times the ball 200A has been successfully thrown and caught without being dropped. The two players 210, 215 would try to achieve the highest possible score without dropping the ball 200A through consecutive tosses and catches. This score is optionally displayed in real-time upon the display 25 of the portable gaming computer 100C.

In one embodiment, the score would be announced by an audio subsystem 80, 95 on the portable gaming computer 100C and therefore heard audibly by the players so they do not need to view the display 25. As discussed previously, the portable gaming computer 100C may be worn by the players 210, 215, on their belt or on their wrist; each player 210, 215 having a portable gaming computer 100C (either orchestrating game play independently, or one as a master and the other as a slave.) This allows the score to be displayed 25 or heard audibly through the speakers 95. In addition background music and/or sound effects may be played by the portable gaming computer 100C in coordination with gaming action. For example, when it is determined that player 210 has dropped the ball 200A a suitable sound effect may be played. Similarly, as the players 210, 215 build up a higher and higher score, more energetic background music may be played.

ADVANCED CATCH: Using the processed data determinations describe above, the portable gaming computer 100C may also keep track of the flight time Δt 310 of the ball 200A between successive throws and catches. This flight time Δt 310 may be used as a primary factor in scoring the game, making for a much more interesting and fun game than traditional catch. For example, the portable gaming computer 100C may assign a high score for a successful catch from player 210 to player 215, with the greatest flight time 310. This would push the players to throw the ball 200A higher and/or farther without dropping the ball 200A. The portable gaming computer 100C may orchestrate game play in a variety of ways.

In addition, the portable gaming computers 100C may display 25 visually or aurally 95 certain values other than the score of the game, for example the height of the last throw may be computed and displayed 25 to the player(s) 210, 215 during play, informing how high they got the ball to go. This value may be computed by the portable gaming computer 100C using timing information and the height equation described previously. Similarly the flight time Δt 310 may be displayed to the player(s) 210, 215, informing how long the ball 200A was in the air. In addition background music and/or sound effects may be played 80 by the portable gaming computer 100C in coordination with gaming action. For example, sounds may be selected and/or varied depending upon how long the ball 200A was in the air prior to a catch. In one embodiment a sound effect is played by the portable gaming computer that varies in pitch, the pitch increasing as the flight time Δt 310 mounts during a toss of the tossable gaming object 200.

In another example, the portable gaming computer 100C may be programmed to simply assign a score based upon repeated successful catches (until a drop), the weighting of each catch being based upon how long the flight time Δt 310 was determined to be. In this way, the fastest method for two players 210, 215 to achieve a high score is to throw the ball 200A high and/or far. Another scoring method would be for the portable gaming computer 100C to actually moderate play; thereby instructing the players that they must achieve a longer flight time Δt 310 in order to advance their score. This may be accomplished by prompting the players 210, 215 after each consecutive throw. For example, the portable gaming computer 100C may require that the players 210, 215 step apart (separate the distance between them) after every 10 successful catches.

In addition to flight time Δt 310, other parameters may be required by the portable gaming computer 100C to enhance difficulty, such as the magnitude of the throw. Because the portable gaming computer 100C may be programmed to determine how hard the ball 200A was thrown, the game may require a throws of increasing difficulty. This may be used along with the flight time 310 data by the portable gaming computer 100C, to determine the trajectory of the throw.

For example, a high acceleration throw that has a short flight time Δt 310 would likely be a “line-drive” throw; while a high acceleration throw with a long flight time Δt 310 would likely be a “pop-up” with a high arc. Because the portable gaming computer 100C may use such characteristic acceleration profile and timing data to determine the ball's trajectory, it may require that the players throw “hard-line-drives” as a means of advancing their score. Alternatively, it may require “high pop-ups” as a means of advancing their score. In further example, because the portable gaming computer 100C may determine if the ball 200A has bounced off the ground based upon the characteristic acceleration profile, the portable gaming computer 100C may also monitor “ground balls” and include them as part of the game.

SOLITARY CATCH: The above gaming examples were described as having two players 210, 215, however, any number of players may participate in the computer orchestrated catch game.

This also includes solitary play. In this example, the portable gaming computer 100C would track how often the player 210 may successively toss and catch the ball 200A to his or herself and also keep score. Additionally, the portable gaming computer 100C may also utilize the flight time 310 data to require the player 210 to continually toss the ball higher and/or farther higher to advance his or her score. In one version of the solitary catch game, the portable gaming computer 100C displays 25 the most recent height achieved by the player 210 and the greatest height achieved by the player 210, thereby motivating the player 210 to keep trying to toss the ball 200A higher and higher. Triumphant music may be played 80 each time the player reaches a new height record.

CATCH OFF A WALL: The solitary catch example described above may be performed by bouncing the ball 200A off a wall, rather than straight up as described above. The portable gaming computer 100C may determine the flight time Δt 310, magnitude of toss, and number of bounces, to orchestrate game play in all the same ways described in the multiplayer game, but with the single player 210 and visa versa.

SIMULATED EGG TOSS: Another possible fun variation of the outdoor catch game is the simulated egg toss. In this game, it is not only whether the player 210 successfully caught the ball 200A, but that the player 210 caught the ball 200A sufficiently delicately enough not to “crack the egg.” When catching a real egg, a player 210 must “cradle” or “cushion” the catch (controlled deceleration) to avoid cracking the simulated egg.

This game is possible because the portable gaming computer 100C may be programmed to set a “crack threshold” in which any deceleration outside the accepted range simulates cracking of the egg. The players 210, 215 must throw the ball 200A back and forth, catching it delicately enough not to crack the simulated egg by exceeding the assigned crack threshold. The difficultly of the game may automatically advance by requiring long and longer flight time Δt 310 and/or changes in the crack threshold as described previously.

The egg catch game may include sound effects played 80 by the portable gaming computer 100C when it is determined that a ball 200A is not caught delicately enough, the sound effect for example simulating the sound of a splattering egg or an exploding bomb. Thus the players 210, 215 can play a game tossing the object 200A back and forth until the egg splatters or the bomb explodes or some other simulated sound is displayed.

DISC CATCH: In another embodiment of the invention analogous to the ball catching gaming paradigms described above, a suitably equipped flying disc 200B may be interfaced by wireless link 202 to the portable gaming computer 100C and used for a variety of fun and engaging flying disc 200B game paradigms. The portable gaming computer 100C may be programmed to keep track of the number of successful consecutive catches, without a drop, as described above.

Likewise, the portable gaming computer 100C may be programmed to automatically increase difficulty by requiring increasing flight times Δt 310 between each toss/catch, as described above, or assign more “points” when scoring to a greater flight time Δt 335 for a given toss. In addition, the portable gaming computer 100C may orchestrate a solitary game by simply monitoring how far a player 210 may toss a disc 200D or how long a player may keep a disc 200B in the air. A single player 210, playing alone may have fun just trying to achieve a high score with a disc 210 that represents the longest toss in distance or the longest toss in flight time Δt 335. Alternately, two or more players 210, 215 may compete against each other, trying to achieve the longest toss. The players 210, 215 may even upload their scores to the internet and compete for the record of the longest toss or other game parameters.

DISC DISTANCE: An alternate flying disc game paradigm may be based on how far a player can toss the disc 200D, basing score on flight time Δt 335 alone, not on catches. In such a game, multiple discs may be used in which the discs all interface wirelessly to the same portable gaming computer 100C, allowing the players to compete in real without having to alternate turns.

FRISBEE™ GOLF: A popular game for flying disc players is “Frisbee™ Golf”; a game in which players toss the disc 200B in a “golfing” game methodology, aiming for specific targets along an 18 hole course. The portable gaming computer 100C keeps score by recording the number of tosses required to reach each target along the course. Multiple discs 200B may be interfaced wirelessly 202, 202′ to the same portable gaming computer 100C allowing the scores of all players to be maintained by a single portable gaming computer 100C. In some embodiments of Frisbee™ Golf that employ an RFID chip 75P within the tossable disc 200B, the golfing targets (i.e. the holes) may be equipped with RFID transceivers 65. Thus, the golfing targets may detect when the RFID enabled disc 200B comes within a close proximity that indicates a successful hit. Such a smart golfing target may also include a wireless communication link 204 to the portable gaming computer of one or more players 210, 215, thereby informing the portable gaming computer 100C, 100C′ that the golfing target was successfully hit.

The portable gaming computer 100C may thereby keep score of the Frisbee™ Golf game. Other projectile games may be similarly configured with physical goals and/or physical targets such that the tossable gaming object 200 (equipped with an RFID chip 100P) must come within a certain close proximity of the physical goal or target, as determined by an RFID transceiver 65 within the goal or target, to increase the gaming score.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. No specific limitation is intended to a particular gaming system or device. Other variations and embodiments are possible in light of above teachings, and it is not intended that this Detailed Description limit the scope of invention, but rather by the Claims following herein.

1. A gaming peripheral device encompassed in a tossable gaming object comprising;
a sensor operatively coupled to a microprocessor for communicating detected signals indicative of a dynamic event involving said tossable gaming object;
said microprocessor programmed to process said signals communicated by said sensor; and,
a wireless transceiver operatively coupled to said microprocessor for transmitting a representation of said processed sensor signals to a portable gaming computer.

2. The gaming peripheral device according to claim 1 wherein said dynamic event is dependent on movement of said gaming peripheral device sufficient to actuate said sensor.

3. The gaming peripheral device according to claim 2 wherein said dynamic event is further dependent on time.

4. The gaming peripheral device according to claim 2 wherein said dynamic event is further dependent on a time varying profile of sensor values.

5. The gaming peripheral device according to claim 2 wherein said dynamic event is further dependent on a previously detected dynamic event.

6. The gaming peripheral device according to claim 2 wherein said dynamic event is further dependent on proximity to said portable gaming computer.

7. The gaming peripheral device according to claim 1 wherein said gaming peripheral device is an RFID chip encompassed in said tossable gaming object.

8. The gaming peripheral device according to claim 1 wherein said tossable gaming object includes one of a ball and a disc

9. The gaming peripheral device according to claim 1 wherein said sensor includes at least one accelerometer

10. A tossable gaming system comprising:
a gaming peripheral device encompassed in a tossable gaming object including;
a sensor operatively coupled to a first microprocessor for communicating detected signals indicative of a dynamic event involving said tossable gaming object;
said first microprocessor programmed to process said signals communicated by said sensor;
a portable gaming computer in wireless communications with said gaming peripheral device including;
a second microprocessor programmed to interactively orchestrate a game in dependence on said processed sensor signals and player interaction signals; and,
a player interface operatively coupled to said second microprocessor for communicating said player interaction signals to said second microprocessor.

11. The tossable gaming system according to claim 10 wherein said player interface includes an audio subsystem for communicating sounds to a player.

12. The tossable gaming system according to claim 11 wherein said sounds includes at least one of alert tones and sound effects.

13. The tossable gaming system according to claim 10 wherein said player interface includes a display for visually communicating at least one of a unit of measure and a message to said player.

14. The tossable gaming system according to claim 10 wherein said interactively orchestrate includes moderating, scorekeeping and officiating over said game.

15. The tossable gaming system according to claim 10 further including a memory operatively coupled to said second microprocessor for storing results of said game.

16. The tossable gaming system according to claim 10 wherein said tossable gaming object is one of a ball and a disc

17. The tossable gaming system according to claim 10 wherein said dynamic event is one of; thrown, caught, and missed.

18. A method for making a tossable gaming peripheral comprising:
providing a first microprocessor programmed to;
process signals communicated by a dynamic event sensor; and,
transmit said processed signals to a second microprocessor;
coupling said dynamic event sensor to said first microprocessor;
coupling a first wireless transceiver to said first microprocessor; and,
encompassing at least said first microprocessor and said first wireless transceiver in a tossable gaming object.

19. The method according to claim 18 further comprising;
providing said second microprocessor wherein said second microprocessor is programmed to interactively orchestrate a game in dependence on said processed sensor signals and player interaction signals;
coupling a second wireless transceiver to said second microprocessor for receiving said processed signals;
coupling a player interface to said second microprocessor for communicating said player interaction signals to said second microprocessor; and,
encompassing said second microprocessor, said operatively coupled second wireless transceiver and said operatively coupled player interface in a portable case.

20. The method according to claim 19 wherein said portable case is dimensioned to be of a size easily worn or hand carried by a player.
